(19) United States
(12) Patent Application Publication
(10) Pub. No.: US 2014/0025661 A1
(43) Pub. Date: Jan. 23, 2014

(54) METHOD OF DISPLAYING SEARCH RESULT DATA, SEARCH SERVER AND MOBILE DEVICE

(71) Applicant: Alibaba Group Holding Limited, Grand Cayman (KY)

(72) Inventor: Jiachao Hu, Hangzhou (CN)

(73) Assignee: Alibaba Group Holding Limited, Grand Cayman (KY)

(21) Appl. No.: 13/946,895

(22) Filed: Jul. 19, 2013

(30) Foreign Application Priority Data
Jul. 23, 2012 (CN) 201210257117.9
Nov. 9, 2012 (CN) 201210449281.X

(51) Int. Cl. G06F 17/30

(52) U.S. Cl. CPC G06F 17/30554
USPC 707/722

(57) ABSTRACT

The present disclosure provides a method of displaying search result data, a search server and a mobile device. The method includes: receiving, at a server, a search request sent by a mobile device, the search request includes a search keyword; performing, by the server, a search based on the search keyword and obtaining search result data, where the search result data includes the search keyword; converting, by the server, the search keyword in the search result data into an abbreviated indicator; and returning, by the server, the search result data that includes the abbreviated indicator, the search result data that includes the abbreviated indicator being used for display on an interface of the mobile device in an abbreviated manner. The present disclosure can improve a utilization rate of an interface space of a mobile device and saves the amount of online traffic for a user.

### CROSS REFERENCE TO RELATED PATENT APPLICATIONS

This application claims foreign priority to Chinese Patent Application No. 201210257117.9 filed on Jul. 23, 2012, entitled “Method of Displaying Search Result Data, Search Server and Mobile Device”, and further claims foreign priority to Chinese Application No. 201210449281.X filed on Nov. 9, 2012, entitled “Method of Displaying Search Result Data, Search Server and Mobile Device”, which claims priority to Chinese Patent Application No. 201210257117.9. Each Chinese Patent Application is hereby incorporated by reference in its entirety.

### TECHNICAL FIELD

The present disclosure relates to the technical field of mobile device search, and in particular, relates to methods of displaying search result data, search servers and mobile devices.

### BACKGROUND

Recently, with the development of mobile device technologies, mobile devices have become one of the major tools for daily online access. Searching desired information in cyberspace of a network by users is one of the major activities of users who surf the Internet.

Due to the limitations of the size and display of mobile devices, the content that is browsed each time is extremely limited when the mobile devices search desired information in cyberspace. Furthermore, search result pages generally display content that contains a search keyword. Since each content item includes the search keyword and some search results will also highlight the search keyword, many content items appear repeatedly in a display. For example, for a search keyword “the People's Republic of China”, an interface of a mobile device displays three search results at one time, which are respectively “Baidu Encyclopedia of the People's Republic of China . . . ”, “Wikipedia of the People's Republic of China . . . ”, and “website of the Central Government of the People's Republic of China . . . ” and include brief descriptions thereof. The search keyword “the People's Republic of China” repeatedly appears. Under the circumstance that information displayed in an interface of a mobile device is very limited, displaying a search keyword in search results not only wastes a large amount of interface space, but also consumes an amount of online traffic of a user.

Therefore, a problem that needs to be resolved urgently by one skilled in the art is to provide a method and an apparatus of displaying search result data to improve an utilization rate of an interface space of a mobile device and save an amount of online traffic of a user.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

The purpose of the present disclosure is to provide a method of displaying search result data to improve a utilization rate of an interface space of a mobile device and save an amount of online traffic of a user.

Correspondingly, the present disclosure also provides a search server and a mobile device to ensure the method to be applied in reality.

In order to solve the aforementioned problem, the present disclosure discloses a method of displaying search result data, which includes:

receiving, at a server, a search request sent by a mobile device, the search request including a search keyword;

performing, by the server, a search based on the search keyword and obtaining search result data, where the search result data includes the search keyword;

converting, by the server, the search keyword in the search result data into an abbreviated indicator;

returning, by the server, the search result data that includes the abbreviated indicator, the search result data that includes the abbreviated indicator being used for display on an interface of the mobile device in an abbreviated manner.

In one embodiment, converting, by the server, the search keyword in the search result data into the abbreviated indicator, includes:

the server marking the search keyword in the search result data as a characteristic block; and

the server converting the characteristic block into the abbreviated indicator.

In some embodiments, the search keyword includes a single search term. The server converting the search keyword in the search result data into the abbreviated indicator includes:

the server converting the search term in the search result data into a designated symbol or a specific symbol having a designated color.

In one embodiment, the search keyword includes multiple search terms. The server converting the search keyword in the search result data into the abbreviated indicator includes:

the server separately converting each search term in the search result data into a designated symbol having a different color, where the color into which each search term is converted is the same as a color of a corresponding search term in a search box of the interface of the mobile device.

In some embodiments, the search keyword includes multiple search terms. The server converting the search keyword in the search result data into the abbreviated indicator includes:

the server separately converting each search terms in the search result data into a different symbol, where the symbol into which each search terms is converted is the same as a symbol label associated with a corresponding search term in a search box of the interface of the mobile device.

The embodiments of the present disclosure further disclose a method of displaying search result data, which includes:

a mobile device sending a search request including a search keyword to a server;

the mobile device receiving search result data returned by the server for the search request, where the search result data includes the search keyword;

the mobile device converting the search keyword in the search result data into an abbreviated indicator; and

the mobile device displaying the search result data that includes the abbreviated indicator in an interface in an abbreviated manner.

In one embodiment, the mobile device converting the search keyword in the search result data into the abbreviated indicator, includes:

the mobile device marking the search keyword in the search result data as a characteristic block; and

the mobile device converting the characteristic block into the abbreviated indicator.

In one instance, the search keyword includes a single search term. The mobile device converting the search keyword in the search result data into the abbreviated indicator, includes:

the mobile device converting the search term in the search result data into a designated symbol or a specific symbol having a designated color.

In some instances, the search keyword includes a plurality of search terms. The mobile device converting the search keyword in the search result data into the abbreviated indicator, includes:

the mobile device separately converting each search term in the search result data into a designated symbol having a different color, where the color into which each search term is converted is the same as a color of a corresponding search term in a search box of the interface of the mobile device.

In some instances, the search keyword includes multiple search terms. The mobile device converting the search keyword in the search result data into the abbreviated indicator, includes:

the mobile device separately converting the search terms in the search result data into different symbols, where a symbol into which a search term is converted is the same as a symbol label of a corresponding search term in a search box of the interface of the mobile device.

The embodiments of the present disclosure further discloses a method of displaying search result data, which includes:

a mobile device sending a search request that includes a search keyword to a server;

the server performing a search based on the search keyword and obtaining search result data, where the search result data includes the search keyword;

the server marking the search keyword in the search result data as a characteristic block; and

the server returning the search result data that includes the characteristic block to the mobile device, the search result data that includes the characteristic block being used by the mobile device to convert the characteristic block into an abbreviated indicator and to display the search result data that includes the abbreviated indicator on an interface thereof in an abbreviated manner.

The embodiments of the present disclosure further disclose a search server, which includes:

a request receiving module used for receiving a search request sent from a mobile device, the search request including a search keyword;

a search module used for performing a search based on the search keyword and obtaining search result data, where the search result data includes the search keyword;

an abbreviated indicator conversion module used for converting the search keyword in the search result data into an abbreviated indicator; and

a sending module used for returning the search result data that includes the abbreviated indicator, the search result data that includes the abbreviated indicator being used for display in an interface of the mobile device in an abbreviated manner.

The embodiments of the present disclosure also disclose a mobile device, which includes:

a request submission module used for sending a search request that includes a search keyword to a server;

a search result receiving module used for receiving the search result data returned by the server for the search request, where the search result data includes the search keyword;

an abbreviation processing module used for converting the search keyword in the search result data into an abbreviated indicator, and

a display module used for displaying the search result data that includes the abbreviated indicator in an interface in an abbreviated manner.

The embodiments of the present disclosure also disclose a search server, which includes:

a request receiving module used for receiving a search request sent by a mobile device, the search request includes a search keyword;

a search module used for performing a search based on the search keyword according to the search request and obtaining search result data, where the search result data includes the search keyword;

a characteristic block marking module used for marking the search keyword in the search result data as a characteristic block; and

a search result returning module used for returning the search result data that includes the characteristic block to the mobile device, where the search result data that includes the characteristic block is used by the mobile device to convert the characteristic block into an abbreviated indicator and to display the search result data that includes the abbreviated indicator on an interface thereof.

Compared with existing technologies, the present disclosure has the following advantages:

The disclosed method converts a search keyword in search result data into an abbreviated indicator and displays the search result data that includes the abbreviated indicator on an interface of a mobile device. Since displaying the abbreviated indicator in the search results saves more interface space of the device as compared to displaying the search keyword, the disclosed method improves a utilization rate of the interface space of the mobile device and saves an amount of online traffic for a user.

In addition, in an exemplary embodiment of the present disclosure, the server may complete the operations of converting the search keyword into the abbreviated indicator. Under such a situation, the server and the mobile device occupy less communication resources and can further save on the amount of the online traffic for the user.

Furthermore, in another exemplary embodiment of the present disclosure, during a display of multiple search keywords, abbreviated indicators having different colors and different symbols may be used to indicate different search keywords to avoid the user from confusion, thus maximizing the use of the interface space of the mobile device.

### BRIEF DESCRIPTION OF THE DRAWINGS

FIG. 1 is a flowchart illustrating a first example method of displaying search result data in accordance with the present disclosure.

FIG. 2 is a flowchart illustrating a second example method of displaying search result data in accordance with the present disclosure.

FIG. 3 is a flowchart illustrating a third example method of displaying search result data in accordance with the present disclosure.

FIG. 4 is a structural diagram illustrating a first example search server in accordance with the present disclosure.

FIG. 5 is a structural diagram illustrating a second example search server in accordance with the present disclosure.

FIG. 6 is a structural diagram illustrating an example mobile device in accordance with the present disclosure.

FIG. 7 is a structural diagram illustrating the example search server as described in FIGS. 4 and 5.

FIG. 8 is a structural diagram illustrating the example mobile device as described in FIG. 6.

### DETAILED DESCRIPTION

In order to facilitate understanding of the above purpose, characteristics and advantages of the present disclosure, the present disclosure is described in further detail in conjunction with accompanying figures and example embodiments.

One main idea of the present disclosure is to convert a search keyword submitted from a user in search result data into an abbreviated indicator. When displaying on an interface of a mobile device, the search result data including the abbreviated indicator is displayed, thus improving a utilization rate of an interface space of the mobile device and saving an amount of the online traffic for the user.

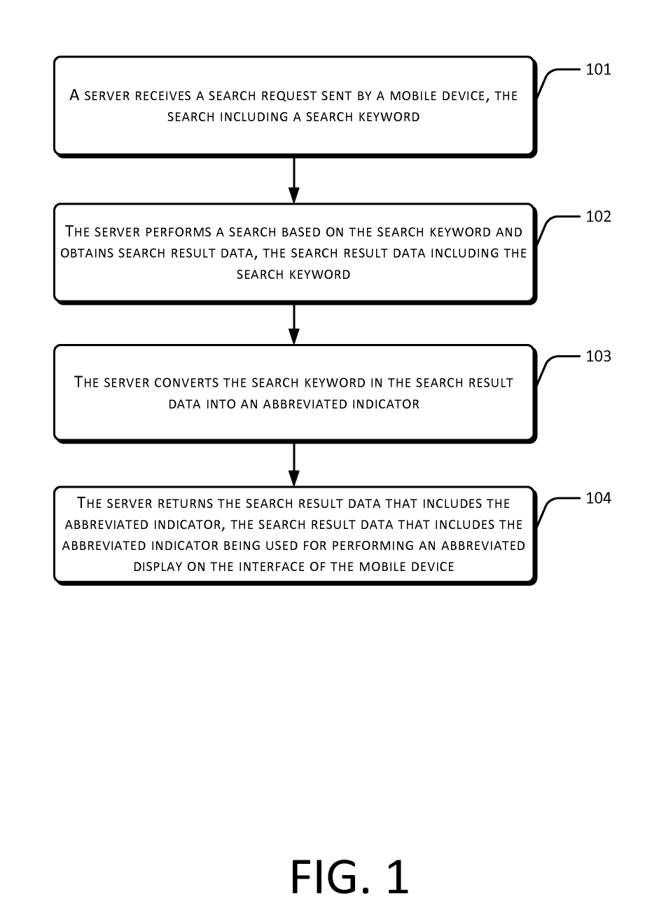

FIG. 1 shows a flowchart of a first example method of displaying search result data, which may include the following:

At block 101, a server receives a search request sent by a mobile device, where the search includes a search keyword.

In a specific implementation, a user may submit a search request that includes a search keyword from a mobile device. The submitted search keyword may include a key search keyword that is submitted from the mobile device to the server using any approach. For example, the user may enter a search keyword in a designated page location (such as a search box), or may click on a certain keyword that has a search engine link on a web page to trigger a search, i.e., the user triggering a submission of the keyword on the web page, etc. The present disclosure does not have any limitation thereon.

At block 102, the server performs a search based on the search keyword and obtains search result data, where the search result data includes the search keyword.

The process of performing a search based on a search keyword is based on functionalities of most search engines in reality. Therefore, the present embodiment of this disclosure can be applied in most of the search functionalities.

In practice, the search keyword may be a single search term, such as “Taobao” entered by the user in a search box. Alternatively, the search keyword may be a plurality of search terms, such as “Taobao, new style, summer fashion” entered by the user in the search box. It should be noted that in the embodiments of the present disclosure, the plurality of search terms may also include multiple search terms that are generated after segmenting a single search keyword. For example, a search keyword submitted by the user may be “milk poisoning in Gansu.” A word segmentation function of a search engine may automatically separate this search keyword into three search terms—“Gansu”, “milk” and “poisoning” for a search. The embodiments of the present disclosure regards such situation of word segmentation as a plurality of search terms.

At block 103, the server converts the search keyword in the search result data into an abbreviated indicator.

In an exemplary embodiment of the present disclosure, block 103 may include the following sub-blocks:

At sub-block S11, the server marks the search keyword in the key search result data as a characteristic block.

At sub-block S12, the server converts the characteristic block into an abbreviated indicator.

It can be understood that the characteristic block may indicate a location of the search keyword in the search result data and a character length of the search keyword. By applying this embodiment, the server may first mark the location and the character length of the search keyword in the search result data, prior to converting the marked location into an abbreviated indicator.

In a specific implementation, the abbreviated indicator may be simple character(s) or symbol(s), provided that less display interface space is occupied as compared to the content of the original search keyword.

As an example of a specific application of the embodiment of this disclosure, when the search keyword is a single search term, the abbreviated indicator may be a designated symbol or a specific symbol with a designated color. For example, the abbreviated indicator for a single search term “cell phone” is a red ellipsis “ . . . ”, details thereof are represented in the following table:

| Search Keyword | Abbreviated Indicator |
|---|---|
| Cell Phone | . . . |

As another example of the specific application of the embodiment of the present disclosure, when the search keyword includes a plurality of search terms, block 103 may include the following sub-blocks:

At sub-block S21, the server separately converts the search terms in the search result data into designated symbols having different colors. Respective colors into which the key search terms have been converted are the same as colors of corresponding search terms in a search box of the interface of the mobile device.

In the present embodiment, the interface of the mobile device may display a search box that includes the search keyword. The plurality of search terms may be displayed in the search box separately using different colors. In such circumstances, abbreviated indicators may be specific symbols associated with colors displayed for the search terms in the search box. Generally, such method facilitates a user to be able to understand content having terms be abbreviated based on differences in colors even if the search results include many terms, thus increasing an amount of content that the interface of the mobile device can display while avoiding reading barriers caused by abbreviations of a large number of terms.

For example, for multiple search terms “Apple” and “cell phone” (which may be two search terms separated by the user using a space key or two search terms generated after a search engine performs a segmentation for a search keyword “Apple cell phone” inputted by the user), the term “Apple” is displayed in blue and the term “cell phone” is displayed in red in the search box. In the search result data, a blue ellipsis“ . . . ” is used as an abbreviated indicator for “Apple” and a red ellipsis “ . . . ” is used as an abbreviated indicator for “cell phone”. The details thereof are represented in the table below:

| Search Term | Abbreviated Indicator |
|---|---|
| Apple (in blue) | . . . (in blue) |
| Cell Phone (in red) | . . . (in red) |

As yet another example of the specific application of the embodiment of the present disclosure, when the search keyword includes a plurality of search terms, block 103 may include the following sub-blocks:

At sub-block S31, the server separately converts the search terms in the search result data into different symbols, where the symbol into which each search term has been converted is the same as a symbol label for a corresponding search term in a search box of the interface of the mobile device.

In the present embodiment, the interface of the mobile device may display a search box that includes the search keyword. The plurality of search terms in the search box are associated with different symbols labels respectively. Under such circumstances, the abbreviated indicators may be corresponding symbols of the symbol labels that are displayed for the search terms in the search box.

For example, for search terms “Apple” and “cell phone,” the term, “Apple” in the search box is associated with a symbol label “” thereafter, and the term “cell phone” is associated with a symbol label “★” thereafter. In the search result data, “” is used as an abbreviated indicator for “Apple” and “★” is used as an abbreviated indicator for “cell phone.” Details thereof are shown in the table below:

| Search Term | Abbreviated Indicator |
|---|---|
| Apple | |
| Cell Phone ★ | ★ |

Furthermore, the above conversion technologies of abbreviated indicators for a plurality of search terms can be combined. For example, for search terms “Apple” and “cell phone,” in the search box, the term “Apple” is displayed in blue and is associated with the symbol label “” and the term “cell phone” is displayed in red and is associated with the symbol label “★.” In the search result data, blue “” is the abbreviated indicator for “Apple” and red “★” is the abbreviated indicator for “cell phone.” Details thereof are indicated in the table below:

| Search Term | Abbreviated Indicator |
|---|---|
| Apple (In blue) | (In blue) |
| Cell Phone★ (In red) | ★ (In red) |

It should be noted that the color of a search term is preferably different from the color of other text that is not the search term in the search result data.

The above conversion methods of abbreviated indicators are used as illustration examples only. One skilled in the art may use any conversion method of abbreviated indicators based on actual circumstances. The present disclosure does not impose limitations thereon.

At block 104, the server returns the search result data that includes the abbreviated indicator. The search result data that includes the abbreviated indicator is used for performing an abbreviated display on the interface of the mobile device.

In the embodiment of the present disclosure, after the mobile device receives the search result data that has the search keyword converted into the abbreviated indicator and is returned by the server, the search result data that includes the abbreviated indicator is displayed on the interface thereof in an abbreviated manner.

The present embodiment may make full use of the powerful processing functionality of the server and have the server complete the operation of converting the search keyword into the abbreviated indicator, without the need of installing additional application program or client program on the mobile device. The server only needs to transmit the search result data that includes the abbreviated indicator. Compared with transmitting complete search result data in the existing technologies, this can reduce the amount of data transmission and the use of communications resources, saving the amount of online traffic for the user and increasing contents that can be displayed on the interface of the mobile device.

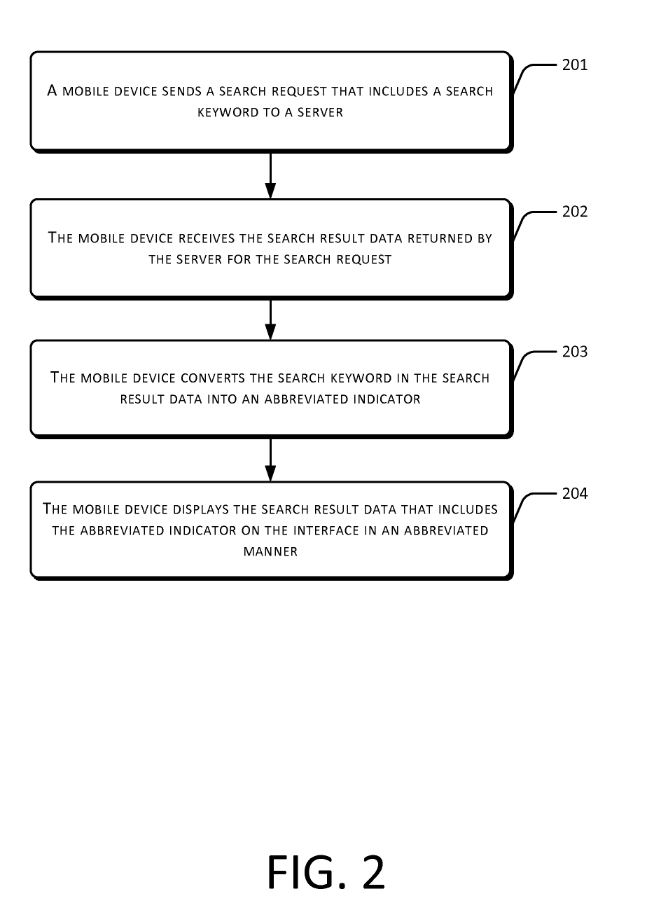

FIG. 2 shows a flowchart illustrating a second example method of displaying search result data, the details of which may include the following blocks:

At block 201, a mobile device sends a search request that includes a search keyword to a server.

In practice, the server will perform a search based on the search keyword submitted by the mobile device and obtain search result data.

At block 202, the mobile device receives the search result data returned by the server for the search request, where the search result data includes the search keyword.

In a specific implementation, the key search keyword may include a single search term or multiple search terms. The multiple search terms may include a plurality of search terms that are submitted or a plurality of search terms that are generated after segmenting a single search term.

At block 203, the mobile device converts the search keyword in the search result data into an abbreviated indicator.

In an exemplary embodiment of the present disclosure, block 203 may include the following sub-blocks:

At sub-block S41, the mobile device marks the search keyword in the search result data as a characteristic block.

At sub-block S42, the mobile device converts the characteristic block into an abbreviated indicator.

It can be understood that the characteristic block can represent a location of the search keyword in the search result data and a character length of the search keyword. By applying the present embodiment, the mobile device may first mark the location and the length of the search keyword in the search result data and then convert the marked location into the abbreviated indicator.

In an exemplary embodiment of the present disclosure, when the search words include a single search term, block 203 may include the following sub-block:

At sub-block S51, the mobile device converts the search keyword in the search result data into a designated symbol or a specific symbol having a designated color.

In another exemplary embodiment of the present disclosure, when the search keyword includes multiple search terms, block 203 may include the following sub-block:

At sub-block S61, the mobile device separately converts the search terms in the search result data into designated symbols with different colors, where the color into which each search term has been converted is the same as the color of a corresponding search term in the search box of the interface of the mobile device.

In the present embodiment, the interface of the mobile device may display a search box that includes the search terms. The search terms in the search box are displayed separately with different colors. Under this circumstance, the abbreviated indicators may use specific symbols of colors displayed by the search terms in the search box.

In yet another exemplary embodiment of the present disclosure, when the search keyword includes a plurality of search terms, block 203 may include the following sub-block:

At sub-block S71, the mobile device separately converts the search terms in the search result data into different symbols, where a symbol into which each search term is converted is the same as a symbol label of a corresponding search term in a search box of the interface of the mobile device.

In the present embodiment, the interface of the mobile device may display a search box that includes the search terms. The search terms in the search box are separately associated with different symbols labels. Under this circumstance, an abbreviated indicator may be a corresponding symbol used by a symbol label of a search term that is displayed in the search box.

At block 204, the mobile device displays the search result data that includes the abbreviated indicator on the interface in an abbreviated manner.

In order to allow one skilled in the art to better understand the present disclosure, the present embodiment is described in further detail using the following example:

1. A user inputs “Apple cell phone IPHONE” in a search input box of a search page of a cell phone and clicks on “search” to trigger and generate a search request, which is submitted to a server.

2. The server automatically separates the search keyword “Apple cell phone IPHONE” into three search terms: “Apple,” “cell phone” and “(PHONE” for performing a search, obtains search result data, and sends the search result data to the cell phone.

3. Upon receiving the search result data, the cell phone marks “Apple” in the search result data as a first characteristic block, marks “cell phone” in the search result data as a second characteristic block, and marks “IPHONE” in the search result data as a third characteristic block.

4. The cell phone respectively invokes a first preset abbreviated indicator conversion rule that corresponds to the first characteristic block, a second preset abbreviated indicator conversion rule that corresponds to the second characteristic block, and a third preset abbreviated indicator conversion rule that corresponds to the third characteristic block. The invocation may be obtained from a local client program of the cell phone or obtained from the server to which a request is sent. For example, the first preset abbreviation indicator conversion rule is to convert the first characteristic block into a red symbol “˜”. The second preset abbreviation indicator conversion rule is to convert the second characteristic block into a yellow symbol “˜”. The third preset abbreviation indicator conversion rule is to convert the third characteristic block into a blue symbol “˜”. Corresponding relationships between the search terms and the abbreviated indicators that are generated are shown in the table below:

| Search Term | Abbreviated Indicator |
|---|---|
| Apple | ~ (in red) |
| Cell Phone | ~ (in yellow) |
| IPHONE | ~ (in blue) |

5. During a process of displaying the search result data, the cell phone follows the first preset abbreviated indicator conversion rule, the second preset abbreviated indicator conversion rule and third preset abbreviated indicator conversion rule to separately convert the first characteristic block into a red symbol “˜”, the second characteristic block into a yellow symbol “·”, and converts the third characteristic block into a blue symbol “˜”. In other words, if search result data found by a certain server is “Apple cell phone—iPhone 4S cell phone is born! The outstanding is now even more outstanding!” The interface of the mobile device displays “˜(red)˜(yellow)˜(blue) 4S” (yellow) is born! The outstanding is now even more outstanding!”

The difference between the present embodiment and the first example method is that the present embodiment can be implemented by configuring the mobile device with a client program or an application program, without making any change to the server, thus saving the improvement cost for the server.

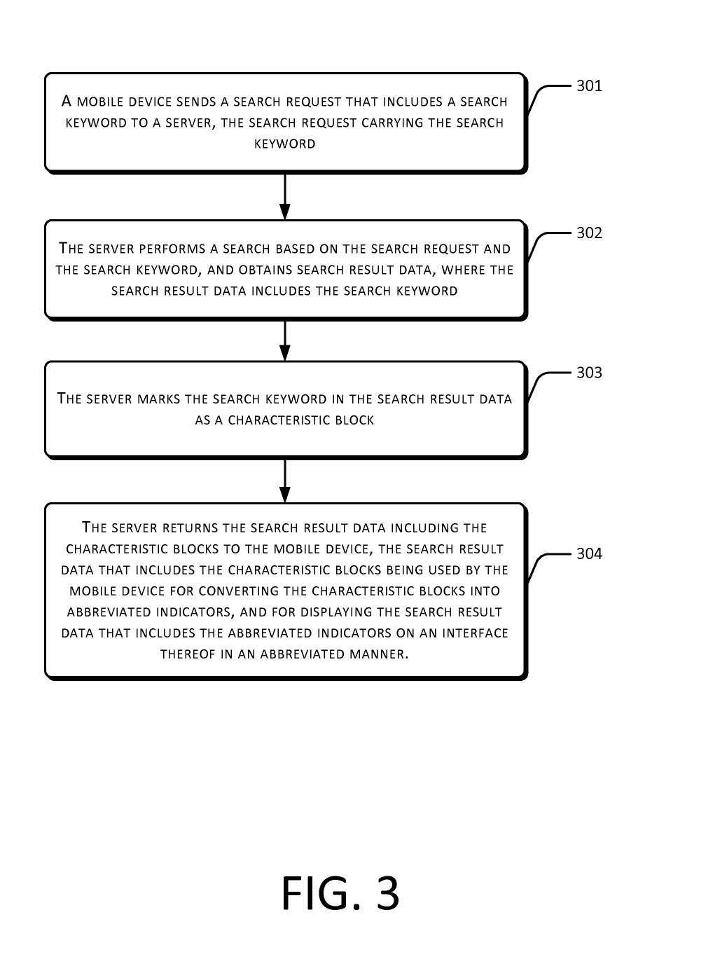

FIG. 3 shows a flowchart illustrating a third method of displaying search result data, the details of which may include the following blocks:

At block 301, a mobile device sends a search request that includes a search keyword to a server. The search request carries the search keyword.

At block 302, the server performs a search based on the search request and the search keyword, and obtains search result data, where the search result data includes the search keyword.

At block 303, the server marks the search keyword in the search result data as a characteristic block.

At block 304, the server returns the search result data including the characteristic blocks to the mobile device. The search result data that includes the characteristic blocks is used by the mobile device for converting the characteristic blocks into abbreviated indicators, and for displaying the search result data that includes the abbreviated indicators on an interface thereof in an abbreviated manner.

Specifically, at block 304, the mobile device receives the search result data that includes the characteristic blocks returned by the server, converts the characteristic blocks into the abbreviated indicators and displays the search result data that includes the abbreviated indicators on the interface thereof in an abbreviated manner.

In order to enable one skilled in the art to better understand the present disclosure, the present embodiment is described in further detail using a complete example:

1. After inputting a search keyword “cell phone” in a search box of a certain shopping website and clicking on a “search” key, a user triggers a server of that shopping website to perform a search operation based on the search keyword “cell phone” and obtain search result data.

2. The server marks location(s) where the search keyword “cell phone” appears as characteristic block(s) and sends search result data that includes information of the characteristic block(s) to the mobile device.

3. The mobile device invokes preset abbreviated indicator conversion rule(s) that correspond(s) to the characteristic block(s). For example, a preset abbreviated indicator conversion rule is to convert a characteristic block into a red symbol “˜”. Specifically, a corresponding relationship between the search keyword and the abbreviated indicator that is generated is shown in the following table:

| Search Keyword | Abbreviated Indicator |
|---|---|
| Cell Phone | ~ (in red) |

4. During a process of displaying the search result data, the mobile device, in accordance with the preset abbreviated indicator conversion rule, marks all characteristic blocks into red symbols “˜”. Specifically, if the search result data found by the certain server search is “cell phone iPhone 4S has an extraordinary mobile camera having a high resolution of eight megapixels and a customized lens having a greater aperture of f/2.4.” An interface of the mobile device displays “˜” (red) iPhone 4S has an extraordinary mobile camera having a high resolution of eight megapixels and a customized lens having a greater aperture of f/2.4.”

The difference between the present embodiment and the first and second example methods is that the present embodiment involves interactive processing between the server and the mobile device during a conversion process of abbreviated indicators. Specifically, during the conversion process of abbreviated indicators, the server marks a search keyword in search result data as a characteristic block. The mobile device identifies and processes the characteristic blocks as specific abbreviated indicators. Since the server only needs to transmit search result data that includes information of characteristic blocks, the amount of data transmission can be reduced as compared to the transmission of complete search result data in existing technologies, thus reducing the use of communications resources and saving the amount of online traffic for users. In addition, in the present embodiment, since the server has processed part of the operations for converting the abbreviated indicators, the consumption of resources of the mobile device can effectively be reduced.

The main points of each embodiment in this disclosure may be different from the other embodiments, and the same or similar portions of the embodiments may be referenced with one another. Also, in order to simplify description, the example methods are described as a series of combinations of actions. However, one skilled in the art should know that the present disclosure is not limited to the described orders of actions because some blocks may be performed in another order or in parallel according to the present disclosure. Further, one skilled in the art should also know that the embodiments described in this disclosure are exemplary embodiments, and actions and modules involved therein may not be essential to the present disclosure.

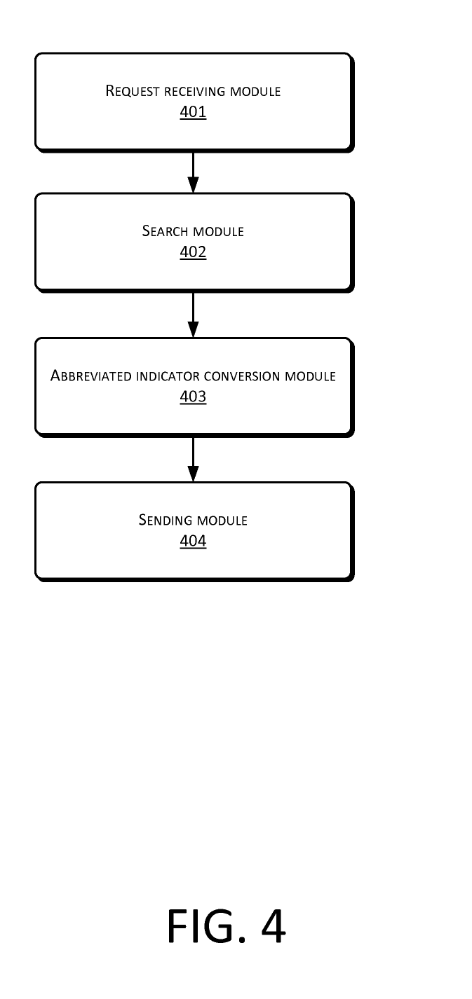

FIG. 4 shows a structural diagram illustrating a first example search server in accordance with the present disclosure, which may include the following modules:

a request receiving module 401 used for receiving a search request sent from a mobile device, the search request including a search keyword;

a search module 402 used for performing a search based on the search keyword and obtaining search result data, where the search result data includes the search keyword;

an abbreviated indicator conversion module 403 used for converting the search keyword in the search result data into an abbreviated indicator; and a sending module 404 used for returning the search result data that includes the abbreviated indicator, the search result data that includes the abbreviated indicator being used for display in an interface of the mobile device in an abbreviated manner.

In an exemplary embodiment of the present disclosure, the abbreviated indicator conversion module 403 may include the following sub-modules:

a characteristic block marking sub-module, used for marking the search keyword in the search result data as a characteristic block; and

a conversion sub-module, used for converting the characteristic block into the abbreviated indicator.

As an example of a specific application of the embodiments of the present disclosure, the search keyword is a single search term. Under this circumstance, the abbreviated indicator conversion module 403 may include the following sub-module:

a first specific conversion sub-module, used for converting the search term in the search result data into a designated symbol or a specific symbol having a designated color.

As another example of the specific application of the embodiments of the present disclosure, the search keyword includes a plurality of search terms. Under this circumstance, the abbreviated indicator conversion module 403 may include the following sub-module:

a second specific conversion sub-module, used for separately converting the search terms in the search result data into designated symbols having different colors, where a color into which a search term is converted is the same as a color of a corresponding search term in a search box of the interface of the mobile device.

As another example of the specific application of the embodiments of the present disclosure, the search keyword includes a plurality of search terms. Under this circumstance, the abbreviated indicator conversion module 403 may include the following sub-module:

a third specific conversion sub-module, used for separately converting the search terms in the search result data into different symbols, where a symbol into which a search term is converted is the same as a symbol label of a corresponding search term in a search box of the interface of the mobile device.

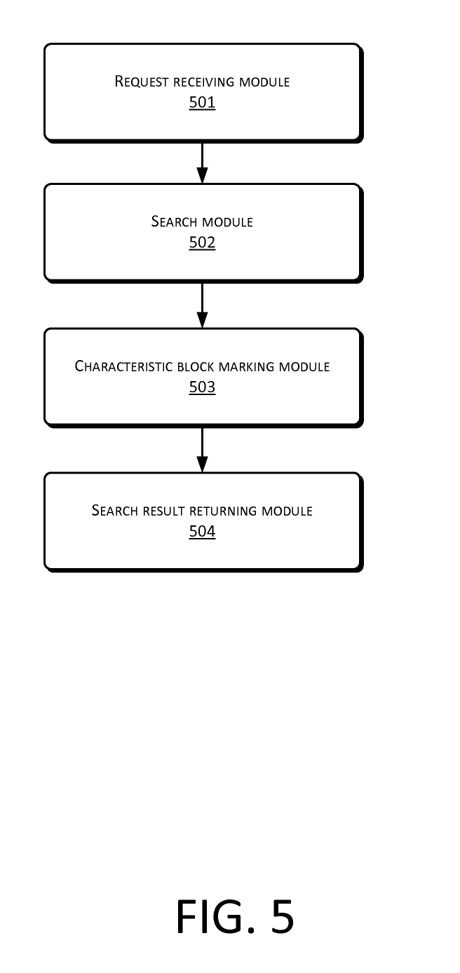

FIG. 5 shows a structural diagram illustrating a second example search server in accordance with the present disclosure, which may specifically include the following modules:

a request receiving module 501 used for receiving a search request sent by a mobile device, the search request includes a search keyword;

a search module 502 used for performing a search based on the search keyword according to the search request and obtaining search result data, where the search result data includes the search keyword;

a characteristic block marking 503 module used for marking the search keyword in the search result data as a characteristic block; and

a search result returning module 504 used for returning the search result data that includes the characteristic block to the mobile device, where the search result data that includes the characteristic block is used by the mobile device to convert the characteristic block into an abbreviated indicator and to display the search result data that includes the abbreviated indicator on an interface thereof.

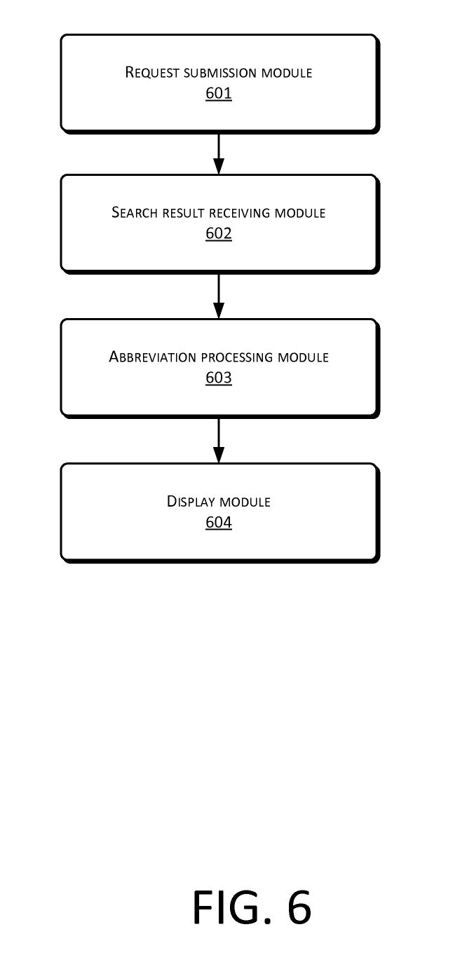

FIG. 6 shows a structural diagram illustrating an example mobile device in accordance with the present disclosure, which may specifically include the following modules:

a request submission module 601 used for sending a search request that includes a search keyword to a server;

a search result receiving module 602 used for receiving the search result data returned by the server for the search request, where the search result data includes the search keyword;

an abbreviation processing module 603 used for converting the search keyword in the search result data into an abbreviated indicator, and

a display module 604 used for displaying the search result data that includes the abbreviated indicator in an interface in an abbreviated manner.

In an exemplary embodiment of the present disclosure, the abbreviation processing module 603 may include the following sub-modules:

a characteristic block marking sub-module, used for marking the search keyword in the search result data as a characteristic block; and

a conversion sub-module, used for converting the characteristic block into the abbreviated indicator.

As an example of a specific application of the embodiments in the present disclosure, the search keyword is a single search term. Under such circumstance, the abbreviation processing module 603 may include the following sub-module:

a first specific conversion sub-module, used for converting the search term in the search result data into a designated symbol or a specific symbol having a designated color.

As another example of the specific application of the embodiments of the present disclosure, the search keyword includes a plurality of search terms. Under this circumstance, the abbreviation processing module 603 may include the following sub-module:

a second specific conversion sub-module, used for separately converting the search terms in the search result data into designated symbols having different colors, where a color into which a search term is converted is the same as a color of a corresponding search term in a search box of the interface of the mobile device.

As another example of the specific application of the embodiments of the present disclosure, the search keyword includes a plurality of search terms. Under this circumstance, the abbreviation processing module 603 may include the following sub-module:

a third specific conversion sub-module, used for separately converting the search terms in the search result data into different symbols, where a symbol into which a search term is converted is the same as a symbol label of a corresponding search term in a search box of the interface of the mobile device.

The descriptions of exemplary apparatuses are relatively simple as these exemplary apparatuses are similar to their counterpart embodiments of exemplary methods. Related details can be found in the embodiments of exemplary methods.

One skilled in the art should understand that the embodiments of the present disclosure may be implemented as methods, systems, or products of computer software. Therefore, the present disclosure may be implemented in forms of hardware, software, or a combination of hardware and software. Further, the present disclosure may be implemented in the form of products of computer software executable on one or more computer readable storage media (including but not limited to disk storage device, CD-ROM, optical storage device, etc.) that include computer readable program instructions.

The present disclosure is described in accordance with flowcharts and/or block diagrams of the exemplary methods, apparatuses (systems) and computer program products. It should be understood that each process and/or block and combinations of the processes and/or blocks of the flowcharts and/or the block diagrams may be implemented in the form of computer program instructions. Such computer program instructions may be provided to a general purpose computer, a special purpose computer, an embedded processor or another processing apparatus having a programmable data processing device to generate a machine, so that an apparatus having the functions indicated in one or more blocks described in one or more processes of the flowcharts and/or one or more blocks of the block diagrams may be implemented by executing the instructions by the computer or the other processing apparatus having programmable data processing device.

Such computer program instructions may also be stored in a computer readable memory device which may cause a computer or another programmable data processing apparatus to function in a specific manner, so that a manufacture including an instruction apparatus may be built based on the instructions stored in the computer readable memory device. That instruction device implements functions indicated by one or more processes of the flowcharts and/or one or more blocks of the block diagrams.

The computer program instructions may also be loaded into a computer or another programmable data processing apparatus, so that a series of operations may be executed by the computer or the other data processing apparatus to generate computer implemented processing. Therefore, the instructions executed by the computer or the other programmable apparatus may be used to implement one or more processes of the flowcharts and/or one or more blocks of the block diagrams.

Although exemplary embodiments of the present disclosure are provided, one skilled in the art may change and modify theses exemplary embodiments upon understanding the underlying inventive concepts thereof. Therefore, claims attached herein are intended to cover the exemplary embodiments and all the changes and modifications that fall into the scope of the present disclosure.

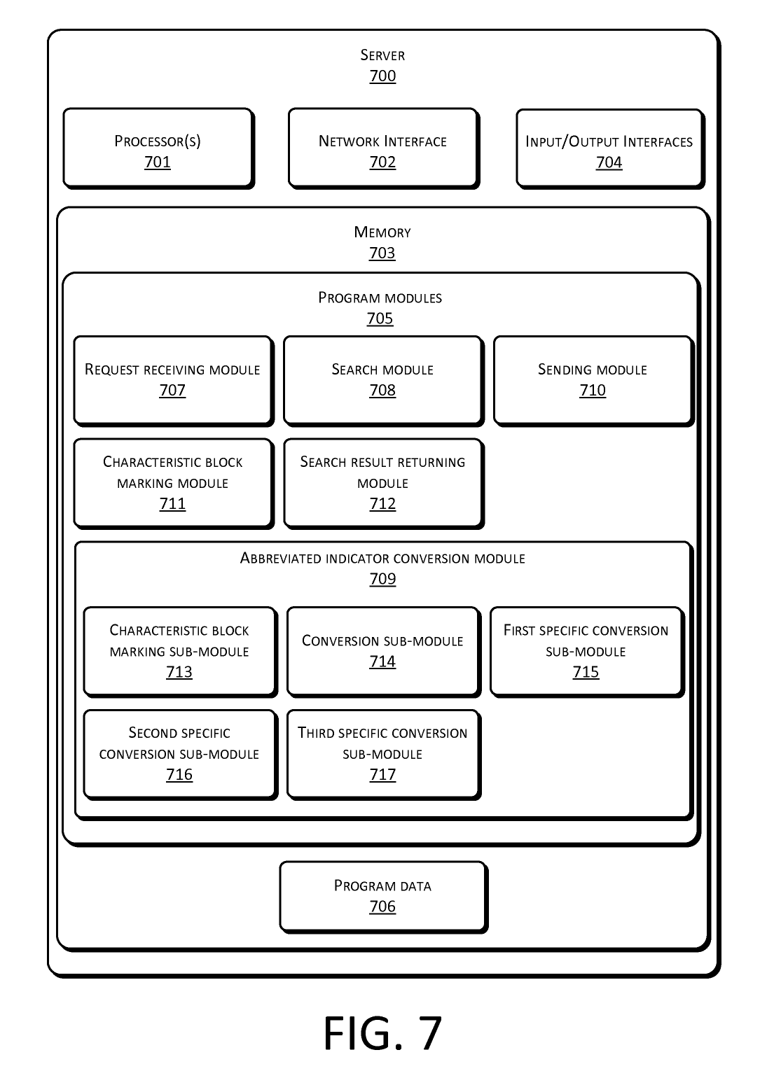

FIG. 7 illustrates an example server 700, such as the server as described above, in more detail. In one embodiment, the server 700 can include, but is not limited to, one or more processors 701, a network interface 702, memory 703, and an input/output interface 704.

The memory 703 may include computer-readable media in the form of volatile memory, such as random-access memory (RAM) and/or non-volatile memory, such as read only memory (ROM) or flash RAM. The memory 703 is an example of computer-readable media.

Computer-readable media includes volatile and non-volatile, removable and non-removable media implemented in any method or technology for storage of information such as computer readable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

The memory 703 may include program modules 705 and program data 706. In one embodiment, the program modules 705 may include a request receiving module 707, a search module 708, an abbreviated indicator conversion module 709, a sending module 710, a characteristic block marking module 711, a search result returning module 712, a characteristic block marking sub-module 713, a conversion sub-module 714, a first specific conversion sub-module 715, a second specific conversion sub-module 716 and a third specific conversion sub-module 717. In one embodiment, the characteristic block marking sub-module 713, the conversion sub-module 714, the first specific conversion sub-module 715, the second specific conversion sub-module 716 and the third specific conversion sub-module 717 may be included in the abbreviated indicator conversion module 709. Details about these program modules and/or sub-modules may be found in the foregoing embodiments described above.

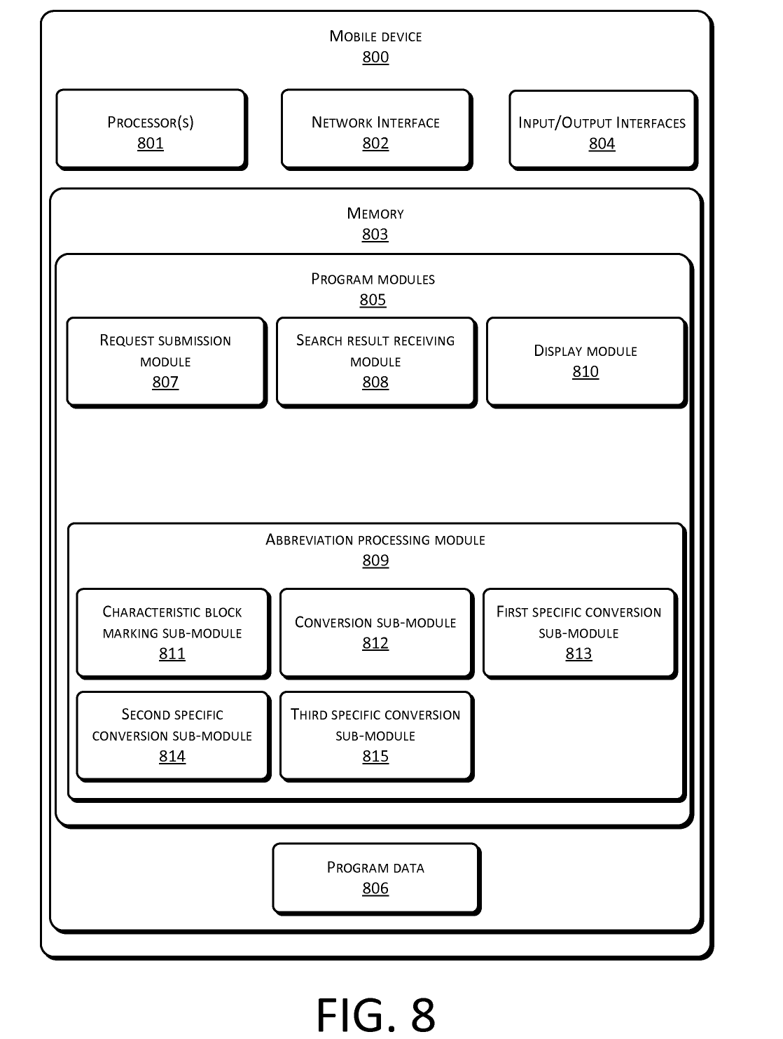

FIG. 8 illustrates an example mobile device 800, such as the mobile device as described above, in more detail. In one embodiment, the mobile device 800 can include, but is not limited to, one or more processors 801, a network interface 802, memory 803, and an input/output interface 804.

The memory 803 may include computer-readable media in the form of volatile memory, such as random-access memory (RAM) and/or non-volatile memory, such as read only memory (ROM) or flash RAM. The memory 803 is an example of computer-readable media.

The memory 803 may include program modules 805 and program data 806. In one embodiment, the program modules 805 may include a request submission module 807, a search result receiving module 808, an abbreviated processing module 809, a display module 810, a characteristic block marking sub-module 811, a conversion sub-module 812, a first specific conversion sub-module 813, a second specific conversion sub-module 814 and a third specific conversion sub-module 815. In one embodiment, the characteristic block marking sub-module 811, the conversion sub-module 812, the first specific conversion sub-module 813, the second specific conversion sub-module 814 and the third specific conversion sub-module 815 may be included in the abbreviated processing module 809. Details about these program modules and/or sub-modules may be found in the foregoing embodiments described above.

Finally, it should be pointed out that any relational terms such as “first” and “second” in this document are only meant to distinguish one entity from another entity or one operation from another operation, but not necessarily request or imply existence of any real-world relationship or ordering between these entities or operations. Moreover, it is intended that terms such as “include”, “have” or any other variants cover non-exclusively “comprising”. Therefore, processes, methods, articles or devices which individually include a collection of features may not only be including those features, but may also include other features that are not listed, or any inherent features of these processes, methods, articles or devices. Without any further limitation, a feature defined within the phrase “include a . . . ” does not exclude the possibility that process, method, article or device that recites the feature may have other equivalent features.

Methods and servers of displaying search result data have been described in the present disclosure in detail above. Exemplary embodiments are employed to illustrate the concept and implementation of the present invention in this disclosure. The exemplary embodiments are only used for better understanding of the method and the core concepts of the present disclosure. Based on the concepts in this disclosure, one of ordinary skills in the art may modify the exemplary embodiments and application fields. All in all, contents in the present disclosure should not be construed as limitations to the present disclosure.

1. A method of displaying search result data, comprising:
receiving a search request sent by a mobile device, wherein the search request includes a search keyword;
performing a search based on the search keyword and obtaining search result data, where the search result data includes the search keyword;
converting the search keyword in the search result data into an abbreviated indicator;
returning the search result data that includes the abbreviated indicator, the search result data that includes the abbreviated indicator being used for display on an interface of the mobile device in an abbreviated manner.

2. The method according to claim 1, wherein converting the search keyword in the search result data into the abbreviated indicator comprises:
marking the search keyword in the search result data as a characteristic block; and
converting the characteristic block into the abbreviated indicator.

3. The method according to claim 1, wherein the search keyword comprises a single search term, and converting the search keyword in the search result data into the abbreviated indicator comprises:
converting the search term in the search result data into a designated symbol or a specific symbol with a designated color.

4. The method according to claim 1, wherein the search keyword comprises a plurality of search terms, and converting the search keyword in the search result data into the abbreviated indicator comprises:
separately converting the plurality of search terms in the search result data into designated symbols with different colors, wherein a color into which each search term is converted is the same as a color of a corresponding search term in a search box of the interface of the mobile device.

5. The method according to claim 1, wherein the search keyword comprises a plurality of search terms, and converting the search keyword in the search result data into the abbreviated indicator comprises:
separately converting the plurality of search terms in the search result data into different symbols, wherein a symbol into which each search term is converted is the same as a symbol label for a corresponding search term in a search box of the interface of the mobile device.

6. The method according to claim 1, further comprising segmenting the search keyword into a plurality of search terms.

7. The method according to claim 6, wherein converting the search keyword in the search result data into the abbreviated indicator comprises:
separately converting the plurality of search terms in the search result data into different symbols or a symbol having different colors.

8. A method of displaying search result data, comprising:
sending a search request including a search keyword to a server;
receiving search result data returned by the server for the search request, where the search result data includes the search keyword;
converting the search keyword in the search result data into an abbreviated indicator; and
displaying the search result data that includes the abbreviated indicator in an interface in an abbreviated manner.

9. The method according to claim 8, wherein converting the search keyword in the search result data into the abbreviated indicator, comprises:
marking the search keyword in the search result data as a characteristic block; and
converting the characteristic block into the abbreviated indicator.

10. The method according to claim 8, wherein the search keyword includes a single search term, and converting the search keyword in the search result data into the abbreviated indicator, comprises:
converting the search term in the search result data into a designated symbol or a specific symbol having a designated color.

11. The method according to claim 8, wherein the search keyword includes a plurality of search terms, and converting the search keyword in the search result data into the abbreviated indicator, comprises:
separately converting each search term in the search result data into a designated symbol having a different color, where the color into which each search term is converted is the same as a color of a corresponding search term in a search box of the interface of the mobile device.

12. The method according to claim 8, wherein the search keyword includes a plurality of search terms, and converting the search keyword in the search result data into the abbreviated indicator, comprises:
separately converting the search terms in the search result data into different symbols, where a symbol into which a search term is converted is the same as a symbol label of a corresponding search term in a search box of the interface of the mobile device.

13. The method according to claim 8, further comprising segmenting the search keyword into a plurality of search terms.

14. The method according to claim 13, wherein converting the search keyword in the search result data into the abbreviated indicator comprises:
separately converting the plurality of search terms in the search result data into different symbols or a symbol having different colors.

15. One or more computer-readable media storing executable instructions that, when executed by one or more processors, cause the one or more processors to perform acts comprising:
receiving a search request that includes a search keyword from a mobile device;
performing a search based on the search keyword according to the search request and obtaining search result data, wherein the search result data includes the search keyword;
marking the search keyword in the search result data as a characteristic block; and
returning the search result data that includes the characteristic block to the mobile device, the search result data that includes the characteristic block being used by the mobile device to convert the characteristic block into an abbreviated indicator and to display the search result data that includes the abbreviated indicator on an interface of the mobile device in an abbreviated manner.

16. The one or more computer-readable media according to claim 15, wherein the characteristic block indicates a location of the search keyword in the search result data.

17. The one or more computer-readable media according to claim 15, wherein the characteristic block indicates a character length of the search keyword.

18. The one or more computer-readable media according to claim 15, wherein the search keyword comprises a plurality of search terms, and the acts further comprise marking the plurality of search terms using different characteristic blocks.

19. The one or more computer-readable media according to claim 18, the acts further comprising invoking different conversion rules for the different characteristic blocks.

20. The one or more computer-readable media according to claim 15, the acts further comprising segmenting the search keyword into a plurality of search terms.
